(19) United States
(12) Patent Application Publication
(10) Pub. No.: US 2025/0220517 A1
(43) Pub. Date: Jul. 3, 2025

(54) HANDOVER MEASUREMENTS ASSOCIATED WITH MULTIPLE THRESHOLD AMOUNTS

(71) Applicant: QUALCOMM Incorporated, San Diego, CA (US)

(72) Inventors: Yongle WU, San Diego, CA (US); Nanrun WU, Beijing (CN); Alexei Yurievitch GOROKHOV, San Diego, CA (US); Jiaheng LIU, Shanghai (CN)

(21) Appl. No.: 18/847,924

(22) PCT Filed: May 13, 2022
(86) PCT No.: PCT/CN2022/092612

§ 371 Date: Sep. 17, 2024

(51) Int. Cl. H04W 36/00; H04B 17/318

(52) U.S. Cl. CPC H04W 36/0058; H04B 17/328; H04W 36/0072

(57) ABSTRACT

Various aspects of the present disclosure generally relate to wireless communication. In some aspects, a user equipment (UE) may transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The UE may monitor the first measurement and the second measurement for triggering a second handover procedure from the second cell to the first cell, wherein a second measurement report is transmitted triggering the second handover procedure if the first measurement is greater than the second measurement by a second threshold amount that is greater than the first threshold amount. Numerous other aspects are described.

### FIELD OF THE DISCLOSURE

Aspects of the present disclosure generally relate to wireless communication and to techniques and apparatuses for handover measurements associated with multiple threshold amounts.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network entities that support communication for a user equipment (UE) or multiple UEs. A UE may communicate with a network entity via downlink communications and uplink communications. “Downlink” (or “DL”) refers to a communication link from the network entity to the UE, and “uplink” (or “UL”) refers to a communication link from the UE to the network entity.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The method may include monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

Some aspects described herein relate to an apparatus for wireless communication at a UE. The apparatus may include a memory and one or more processors coupled to the memory. The one or more processors may be configured to transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The one or more processors may be configured to monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

Some aspects described herein relate to a non-transitory computer-readable medium that stores a set of instructions for wireless communication by a UE. The set of instructions, when executed by one or more processors of the UE, may cause the UE to transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The set of instructions, when executed by one or more processors of the UE, may cause the UE to monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

Some aspects described herein relate to an apparatus for wireless communication. The apparatus may include means for transmitting, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The apparatus may include means for monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

Aspects generally include a method, apparatus, system, computer program product, non-transitory computer-readable medium, user equipment, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of an open radio access network architecture, in accordance with the present disclosure.

FIG. 4 is a diagram illustrating an example of make-before-break handover, in accordance with the present disclosure.

FIG. 5 is a diagram illustrating an example of a block diagram associated with performing handover measurements associated with multiple threshold amounts, in accordance with the present disclosure.

FIG. 6 is a diagram of an example associated with handover measurements associated with multiple threshold amounts, in accordance with the present disclosure.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

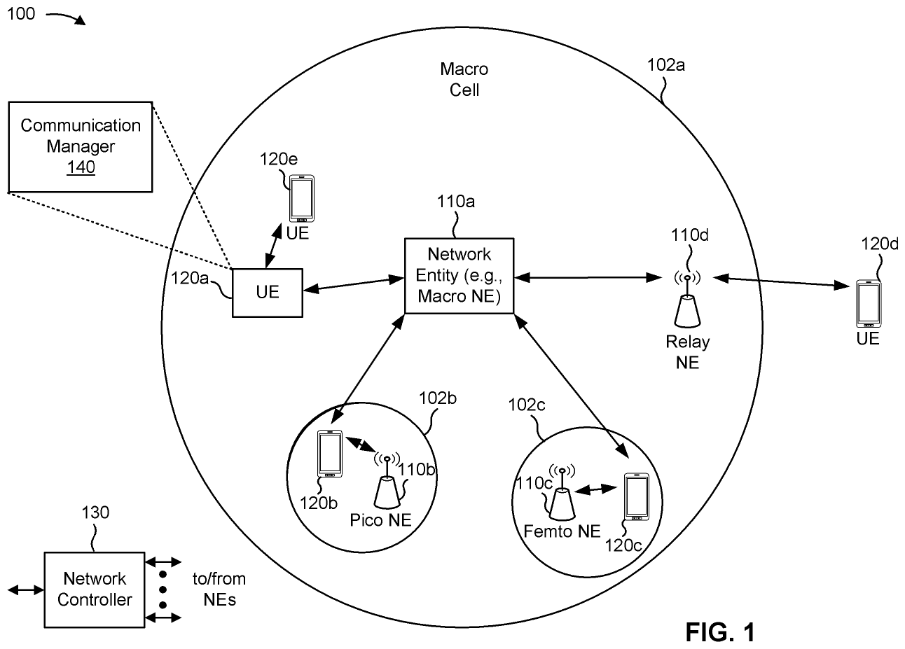

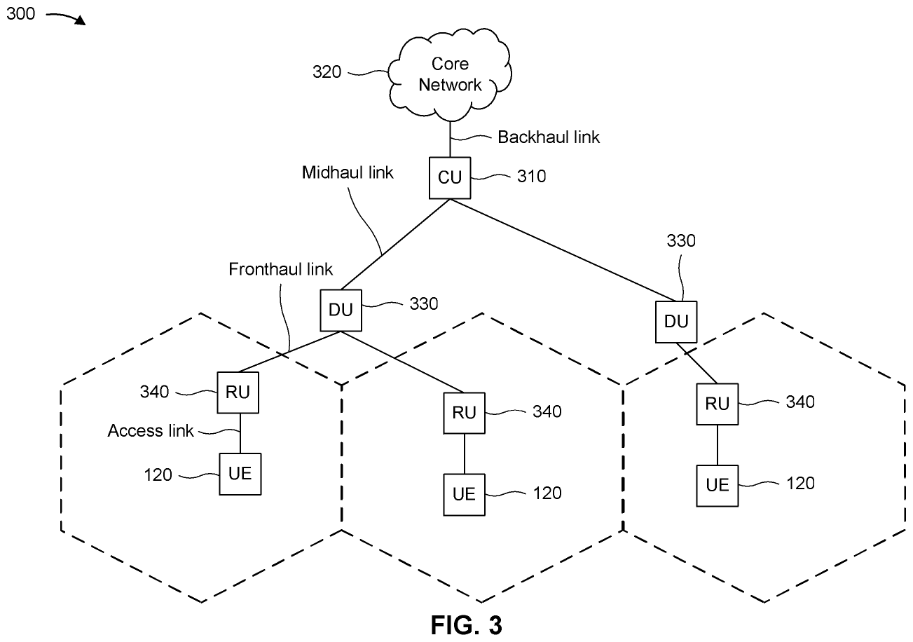

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network entities (NEs) 110 (shown as a NE 110a, a NE 110b, a NE 110c, and a NE 110d), a user equipment (UE) 120 or multiple UEs 120 (shown as a UE 120a, a UE 120b, a UE 120c, a UE 120d, and a UE 120e), and/or other network nodes or entities. A network entity 110 is an entity that communicates with UEs 120. A network entity 110 may include, for example, an NR base station, an LTE base station, a Node B, an eNB (e.g., in 4G), a gNB (e.g., in 5G), an access point, a transmission reception point (TRP), and/or a disaggregated portion of a base station according to an open radio access network (O-RAN) architecture or the like, such as a centralized unit (CU), a distributed unit (DU), or a radio unit (RU), which is described in more detail in connection with FIG. 3. Each network entity 110 may provide communication coverage for a particular geographic area. In the Third Generation Partnership Project (3GPP), the term “cell” can refer to a coverage area of a network entity 110 and/or a network entity subsystem serving this coverage area, depending on the context in which the term is used.

A network entity 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network entity 110 for a macro cell may be referred to as a macro network entity or macro NE. A network entity 110 for a pico cell may be referred to as a pico network entity or pico NE. A network entity 110 for a femto cell may be referred to as a femto network entity, a femto NE, or an in-home network entity. In the example shown in FIG. 1, the NE 110a may be a macro network entity for a macro cell 102a, the NE 110b may be a pico network entity for a pico cell 102b, and the NE 110c may be a femto network entity for a femto cell 102c. A network entity 110 may support one or multiple (e.g., three) cells.

In some examples, a cell may not necessarily be stationary, and the geographic area of the cell may move according to the location of a network entity 110 that is mobile (e.g., a mobile base station). In some examples, the network entity 110 may be interconnected to one another and/or to one or more other network entity 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network entity 110 or a UE 120) and send a transmission of the data to a downstream station (e.g., a UE 120 or a network entity 110). A relay station may be a UE 120 that can relay transmissions for other UEs 120. In the example shown in FIG. 1, the NE 110d (e.g., a relay network entity) may communicate with the NE 110a (e.g., a macro network entity) and the UE 120d in order to facilitate communication between the NE 110a and the UE 120d. A network entity 110 that relays communications may be referred to as a relay station, a relay network entity, a relay, or the like.

The wireless network 100 may be a heterogeneous network that includes network entities 110 of different types, such as macro network entities, pico network entities, femto network entities, relay network entities, or the like. These different types of network entities 110 may have different transmit power levels, different coverage areas, and/or different impacts on interference in the wireless network 100. For example, macro network entities may have a high transmit power level (e.g., 5 to 40 watts) whereas pico network entities, femto network entities, and relay network entities may have lower transmit power levels (e.g., 0.1 to 2 watts).

A network controller 130 may couple to or communicate with a set of network entities 110 and may provide coordination and control for these network entities 110. The network controller 130 may communicate with the network entities 110 via a backhaul communication link. The network entities 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network entity 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network entity 110 associated with a first cell, a measurement report triggering a first handover procedure from the first cell to a second cell, wherein the measurement report is transmitted to the network entity 110 based at least in part on a second measurement associated with the second cell being greater than a first measurement associated with the first cell by a first threshold amount; and monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount. Additionally, or alternatively, the communication manager 140 may perform one or more other operations described herein.

As indicated above, FIG. 1 is provided as an example. Other examples may differ from what is described with regard to FIG. 1.

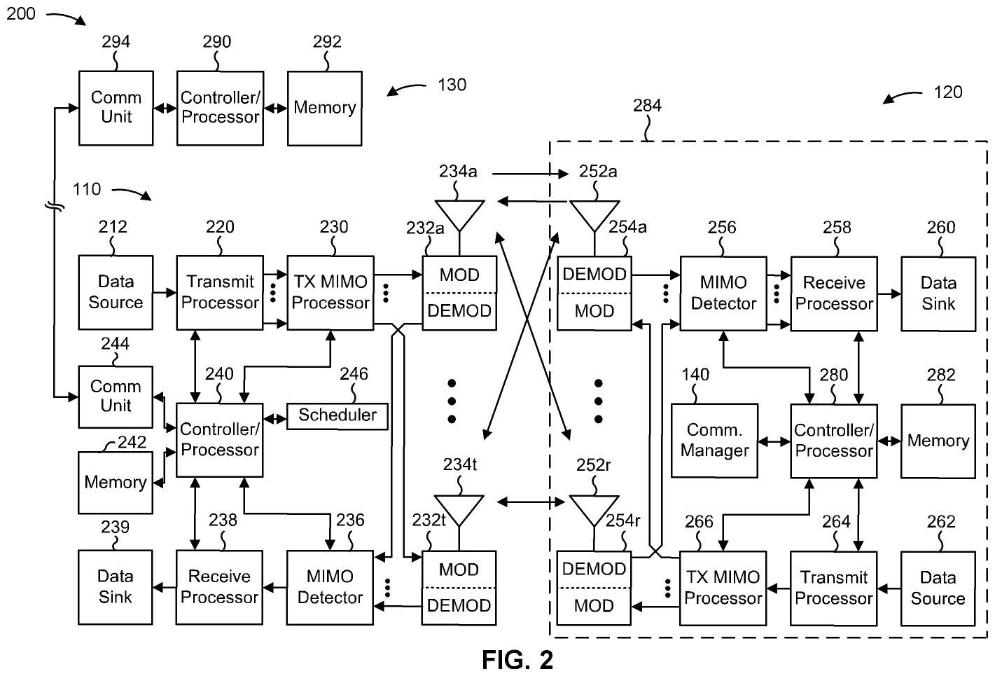

FIG. 2 is a diagram illustrating an example 200 of a network entity 110 in communication with a UE 120 in a wireless network 100, in accordance with the present disclosure. The network entity 110 may be equipped with a set of antennas 234a through 234t, such as T antennas (T≥1). The UE 120 may be equipped with a set of antennas 252a through 252r, such as R antennas (R≥1).

At the network entity 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network entity 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network entity 110 and/or other network entities 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

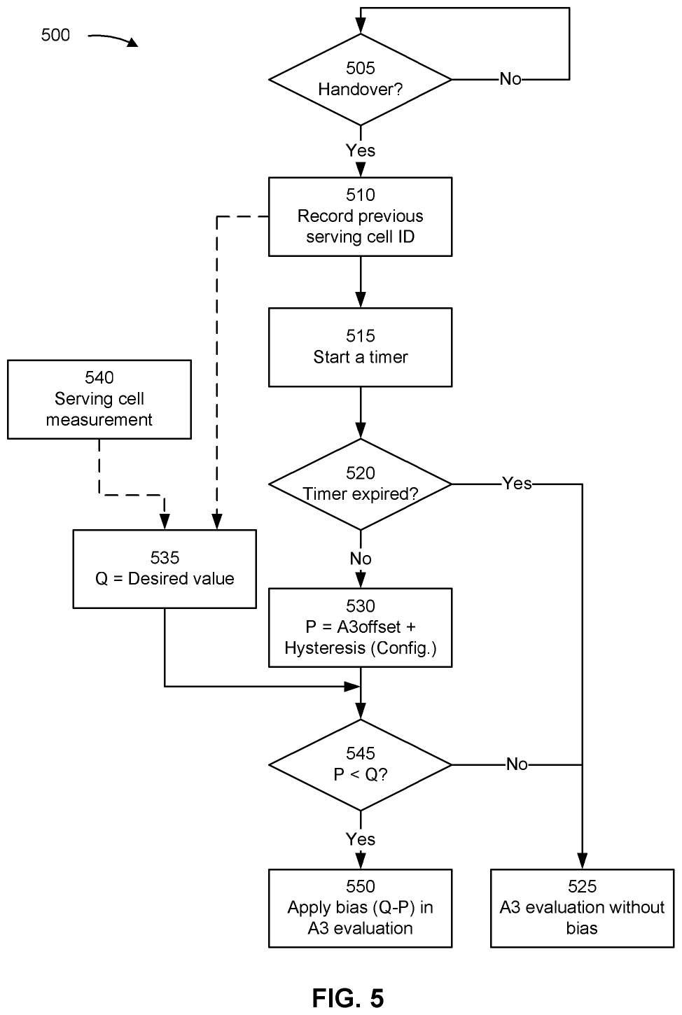

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network entity 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity 110 may include a communication unit 244 and may communicate with the network controller 130 via the communication unit 244. The network entity 110 may include a scheduler 246 to schedule one or more UEs 120 for downlink and/or uplink communications. In some examples, the modem 232 of the network entity 110 may include a modulator and a demodulator. In some examples, the network entity 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

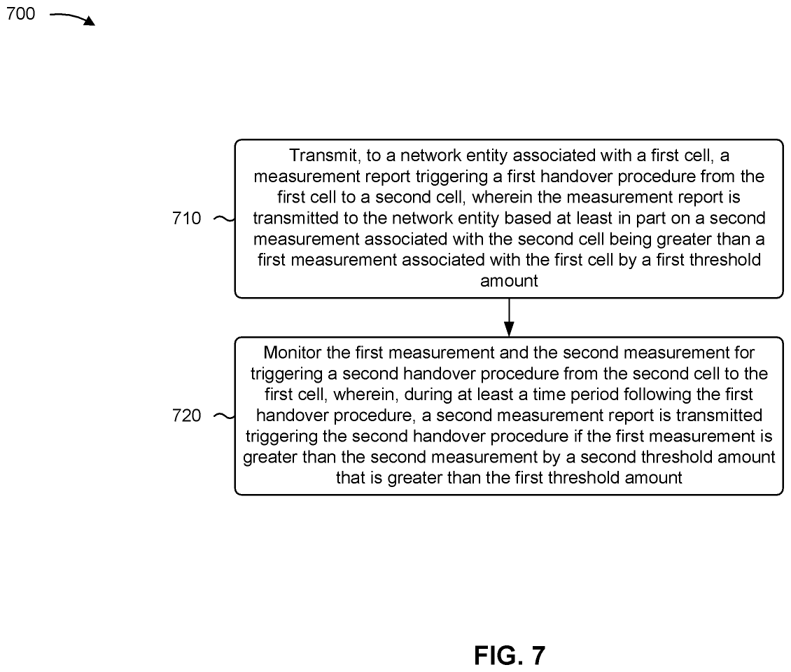

The controller/processor 240 of the network entity 110, the controller/processor 280 of the UE 120, and/or any other component(s) of FIG. 2 may perform one or more techniques associated with handover measurements associated with multiple threshold amounts, as described in more detail elsewhere herein. For example, the controller/processor 240 of the network entity 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the network entity 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity 110 and/or the UE 120, may cause the one or more processors, the UE 120, and/or the network entity 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for transmitting, to a network entity 110 associated with a first cell, a measurement report triggering a first handover procedure from the first cell to a second cell, wherein the measurement report is transmitted to the network entity 110 based at least in part on a second measurement associated with the second cell being greater than a first measurement associated with the first cell by a first threshold amount; and/or means for monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of an O-RAN architecture, in accordance with the present disclosure. As shown in FIG. 3, the O-RAN architecture may include a CU 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station (e.g., an eNB or a gNB) is provided by a DU 330 and one or more RUs 340 that communicate over a fronthaul link. Accordingly, as described herein, a network entity 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

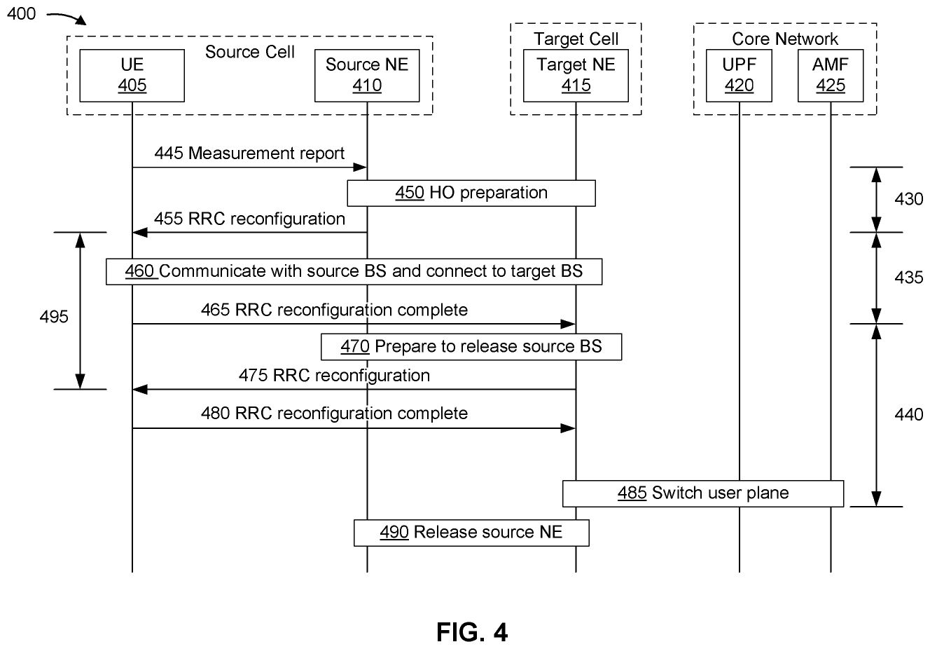

FIG. 4 is a diagram illustrating an example 400 of make-before-break handover, in accordance with the present disclosure.

As shown in FIG. 4, a make-before-break (MBB) handover procedure may involve a UE 405, a source network entity 410, a target network entity 415, a user plane function (UPF) device 420, and an access and mobility management function (AMF) device 425. The UE 405 may correspond to the UE 120 described elsewhere herein. The source network entity 410 and/or the target network entity 415 may correspond to the network entity 110 described elsewhere herein. The UPF device 420 and/or the AMF device 425 may correspond to the network controller 130 described elsewhere herein. The UE 405 and the source network entity 410 may be connected (e.g., may have an RRC connection) via a serving cell or a source cell, and the UE 405 may undergo a handover to the target network entity 415 via a target cell. The UPF device 420 and/or the AMF device 425 may be located within a core network. The source network entity 410 and the target network entity 415 may be in communication with the core network for mobility support and user plane functions. The MBB handover procedure may include an enhanced MBB (eMBB) handover procedure.

As shown, the MBB handover procedure may include a handover preparation phase 430, a handover execution phase 435, and a handover completion phase 440. During the handover preparation phase 430, the UE 405 may report measurements that cause the source network entity 410 and/or the target network entity 415 to prepare for handover and trigger execution of the handover. During the handover execution phase 435, the UE 405 may execute the handover by performing a random access procedure with the target network entity 415 and establishing an RRC connection with the target network entity 415. During the handover completion phase 440, the source network entity 410 may forward stored communications associated with the UE 405 to the target network entity 415, and the UE 405 may be released from a connection with the source network entity 410.

As shown by reference number 445, the UE 405 may perform one or more measurements, and may transmit a measurement report to the source network entity 410 based at least in part on performing the one or more measurements (e.g., serving cell measurements and/or neighbor cell measurements). The measurement report may indicate, for example, an RSRP parameter, an RSRQ parameter, an RSSI parameter, a signal-to-noise ratio (SNR) parameter, and/or a signal-to-interference-plus-noise-ratio (SINR) parameter (e.g., for the serving cell and/or one or more neighbor cells). The source network entity 410 may use the measurement report to determine whether to trigger a handover to the target network entity 415. For example, if one or more measurements satisfy a condition, then the source network entity 410 may trigger a handover of the UE 405 to the target network entity 415.

For example, a measurement report may trigger a handover procedure if the target cell (sometimes referred to as a neighbor cell) becomes offset better than the source cell (sometimes referred to as a serving cell and/or a special cell (SpCell)). In some cases, the target cell becoming offset better than the source cell is referred to as an A3 event or an A3 measurement event. Put another way, an A3 measurement event provides a handover triggering mechanism based upon relative measurement results, such as when an RSRP measurement, an RSRQ measurement, an RSSI measurement, an SNR measurement, an SINR measurement, or a similar measurement of a neighbor cell is stronger than the RSRP, RSRQ, RSSI, SNR, SINR, or similar measurement of the serving cell. In some aspects, an A3 measurement event may be triggered according to the condition Mn+Ofn+Ocn−Hys>Mp+Ofp+Ocp+Off (sometimes referred to as the trigger condition or entering condition, and which may alternatively be expressed as Mn+Ofn+Ocn>Mp+Ofp+Ocp+Off+Hys), and handover to the neighbor cell may be cancelled according to the condition Mn+Ofn+Ocn+Hys<Mp+Ofp+Ocp+Off (sometimes referred to as the cancellation condition or leaving condition). For these conditions, Mn is the measurement result of the neighboring cell (e.g., RSRP, RSRQ, RSSI, SNR, SINR, or the like), Ofn is the measurement object specific offset of a reference signal of the neighbor cell (sometimes referred to as offsetMO) and defined within measObjectNR corresponding to the frequency of the neighboring cell), Ocn is the cell specific offset of the neighbor cell (sometimes referred to as cellIndividualOffset and defined within measObjectNR corresponding to the frequency of the neighbor cell, and set to zero if not configured for the neighbor cell), Mp is the measurement result of the serving cell (e.g., RSRP, RSRQ, RSSI, SNR, SINR, or the like), Ofp is the measurement object specific offset of the SpCell (sometimes referred to as offsetMO and defined within measObjectNR corresponding to the serving cell), Ocp is the cell specific offset of the serving cell (sometimes referred to as cellIndividualOffset and defined within measObjectNR corresponding to the serving cell, and set to zero if not configured for the neighbor cell), Off is the offset parameter associated with the triggering event (sometimes referred to as a3-Offset and defined within reportConfigNR), and Hys is the hysteresis parameter associated with the triggering event (sometimes referred to as hysteresis and defined within reportConfigNR).

As shown by reference number 450, the source network entity 410 and the target network entity 415 may communicate with one another to prepare for a handover of the UE 405. As part of the handover preparation, the source network entity 410 may transmit a handover request to the target network entity 415 to instruct the target network entity 415 to prepare for the handover. The source network entity 410 may communicate RRC context information associated with the UE 405 and/or configuration information associated with the UE 405 to the target network entity 415. The target network entity 415 may prepare for the handover by reserving resources for the UE 405. After reserving the resources, the target network entity 415 may transmit an acknowledgement (ACK) to the source network entity 410 in response to the handover request.

As shown by reference number 455, the source network entity 410 may transmit an RRC reconfiguration message to the UE 405. The RRC reconfiguration message may include a handover command instructing the UE 405 to execute a handover procedure from the source network entity 410 to the target network entity 415. The handover command may include information associated with the target network entity 415, such as a random access channel (RACH) preamble assignment for accessing the target network entity 415. Reception of the RRC reconfiguration message, including the handover command, by the UE 405 may trigger the start of the handover execution phase 435.

As shown by reference number 460, during the handover execution phase 435 of the MBB handover, the UE 405 may execute the handover by performing a random access procedure with the target network entity 415 (e.g., including synchronization with the target network entity 415) while continuing to communicate with the source network entity 410. For example, while the UE 405 is performing the random access procedure with the target network entity 415, the UE 405 may transmit uplink data, uplink control information, and/or an uplink reference signal (e.g., a sounding reference signal) to the source network entity 410, and/or may receive downlink data, downlink control information, and/or a downlink reference signal from the source network entity 410.

As shown by reference number 465, upon successfully establishing a connection with the target network entity 415 (e.g., via a random access procedure), the UE may transmit an RRC reconfiguration completion message to the target network entity 415. Reception of the RRC reconfiguration message by the target network entity 415 may trigger the start of the handover completion phase 440.

As shown by reference number 470, the source network entity 410 and the target network entity 415 may communicate with one another to prepare for release of the connection between the source network entity 410 and the UE 405. In some aspects, the target network entity 415 may determine that a connection between the source network entity 410 and the UE 405 is to be released, such as after receiving the RRC reconfiguration message from the UE 405. In this case, the target network entity 415 may transmit a handover connection setup completion message to the source network entity 410. The handover connection setup completion message may cause the source network entity 410 to stop transmitting data to the UE 405 and/or to stop receiving data from the UE 405. Additionally, or alternatively, the handover connection setup completion message may cause the source network entity 410 to forward communications associated with the UE 405 to the target network entity 415 and/or to notify the target network entity 415 of a status of one or more communications with the UE 405. For example, the source network entity 410 may forward, to the target network entity 415, buffered downlink communications (e.g., downlink data) for the UE 405 and/or uplink communications (e.g., uplink data) received from the UE 405. Additionally, or alternatively, the source network entity 410 may notify the target network entity 415 regarding a PDCP status associated with the UE 405 and/or a sequence number to be used for a downlink communication with the UE 405.

As shown by reference number 475, the target network entity 415 may transmit an RRC reconfiguration message to the UE 405 to instruct the UE 405 to release the connection with the source network entity 410. Upon receiving the instruction to release the connection with the source network entity 410, the UE 405 may stop communicating with the source network entity 410. For example, the UE 405 may refrain from transmitting uplink communications to the source network entity 410 and/or may refrain from monitoring for downlink communications from the source network entity 410.

As shown by reference number 480, the UE may transmit an RRC reconfiguration completion message to the target network entity 415 to indicate that the connection between the source network entity 410 and the UE 405 is being released or has been released.

As shown by reference number 485, the target network entity 415, the UPF device 420, and/or the AMF device 425 may communicate to switch a user plane path of the UE 405 from the source network entity 410 to the target network entity 415. Prior to switching the user plane path, downlink communications for the UE 405 may be routed through the core network to the source network entity 410. After the user plane path is switched, downlink communications for the UE 405 may be routed through the core network to the target network entity 415. Upon completing the switch of the user plane path, the AMF device 425 may transmit an end marker message to the source network entity 410 to signal completion of the user plane path switch. As shown by reference number 490, the target network entity 415 and the source network entity 410 may communicate to release the source network entity 410.

As part of the MBB handover procedure, the UE 405 may maintain simultaneous connections with the source network entity 410 and the target network entity 415 during a time period 495. The time period 495 may start at the beginning of the handover execution phase 435 (e.g., upon reception by the UE 405 of a handover command from the source network entity 410) when the UE 405 performs a random access procedure with the target network entity 415. The time period 495 may end upon release of the connection between the UE 405 and the source network entity 410 (e.g., upon reception by the UE 405 of an instruction, from the target network entity 415, to release the source network entity 410). By maintaining simultaneous connections with the source network entity 410 and the target network entity 415, the handover procedure can be performed with zero or a minimal interruption to communications, thereby reducing latency.

In some cases, the UE 405 may be configured with a relatively small offset (e.g., Off and/or a3-Offset) and/or hysteresis (e.g., Hys and/or hysteresis), which may result in the UE 405 easily triggering handover procedures and thus switching back and forth between cells. A UE 405 repeatedly switching back-and-forth between cells is sometimes referred to as a “ping-pong” handover. For example, with respect to the A3 measurement event described above in connection with reference number 445, one or more of Off or Hys may be relatively small, thus easily triggering a ping-pong handover as the target cell and the source cell become offset slightly better than each other. A ping-pong handover may result in increased signaling overhead used to perform the handover procedures between two or more cells, resulting in increased latency and decreased throughput.

In some cases, in an effort to avoid a ping-pong handover or similar cell switching behavior, a UE 405 may be configured with a larger offset (e.g., a larger Off and/or a3-Offset) and/or a larger hysteresis parameter (e.g., Hys and/or hysteresis), making it more difficult to trigger a handover procedure (and thus making it more difficult to trigger a ping-pong handover between two cells). However, such an approach may suppress a handover procedure when it would otherwise be desirable to switch cells. For example, if a neighbor cell is better than a serving cell and the RSRP or similar parameter of the cells have little fluctuation, a handover may be blocked even though it would be desirable for the UE 405 to switch to the neighbor cell. Or, in the case of a rapidly moving UE 405 (such as a UE 405 on a high-speed train or the like), configuring the UE 405 with too large an offset (e.g., Off and/or a3-Offset) and/or too large a hysteresis parameter (e.g., Hys and/or hysteresis) may result in a delayed measurement report from the UE 405 to the source NE 410 (as described in connection with reference number 445), which may result in disrupted communications and even radio link failure.

Some techniques and apparatuses described herein enable regular measurement reports that trigger handover procedures using a relatively small offset and/or hysteresis parameter, while preventing ping-pong handover or otherwise switching back-and-forth between neighboring cells. In some aspects, a UE (e.g., UE 405) may apply a penalty or a bias to a measurement associated with a previous serving cell to avoid frequent handovers. In some aspects, applying a penalty or a bias to a measurement associated with a previous serving cell may beneficially prevent the UE and/or one or more network entities from switching back to a previous serving cell within a time period, while permitting the UE to trigger a handover to another neighboring cell (e.g., a non-previous serving cell) during the time period if the configured A3 measurement event conditions are met. As a result, ping-pong handovers may be reduced or eliminated, thus reducing signaling overhead used to perform handover procedures and leading to decreased latency and increased throughput, while coverage may be beneficially increased as a UE is not impeded from switching to other neighboring cells when it is beneficial to do so, thereby resulting in a more efficient usage of network resources.

As indicated above, FIG. 4 is provided as an example. Other examples may differ from what is described with respect to FIG. 4.

FIG. 5 is a diagram illustrating an example 500 of a block diagram associated with performing handover measurements associated with multiple threshold amounts, in accordance with the present disclosure.

According to some aspects, the UE 405 described in connection with FIG. 4 or a similar UE (e.g., UE 120) may perform measurements and transmit regular measurement reports (such as the measurement report described in connection with reference number 445) to trigger a handover procedure, such as an A3 measurement event, for some neighboring cells, while applying a bias to other neighboring cells (such as a previous serving cell) in order to discourage cell selection of certain cells and thereby avoid ping-pong handovers. In such aspects, the UE 405 may apply the bias to neighboring cells, such as a previous serving cell, when evaluating an A3 event by replacing a network configured offset parameter (e.g., Off and/or a3-offset) and/or hysteresis parameter (e.g., Hys and/or hysteresis) with a larger parameter such that, at least for a time period following handover, the UE 405 may only transmit an A3 measurement report associated with the previous serving cell if the previous serving cell becomes offset significantly better than a current serving cell.

More particularly, as shown by reference number 505, a network entity (e.g., the source network entity 410) may determine if a handover procedure should be performed. For example, the UE 405 may determine if an A3 measurement event or the like has occurred, which may prompt the UE 405 to transmit a measurement report to a network entity (e.g., the source network entity 410) to trigger a handover procedure. If the A3 measurement event or the like has not occurred (as shown as “No” in the block indicated by the reference number 505), the UE 405 may continue to perform certain measurements (e.g., RSRP, SNR, or the like) until a handover procedure is triggered. Once the handover procedure conditions are met (e.g., once the A3 measurement event has occurred, as shown by “Yes” at the block indicated by reference number 505), the UE 405 may transmit a measurement report to the source network entity 410 indicating that the event has occurred, and a handover procedure may be performed, such as the procedure described in connection with FIG. 4 or a substantially similar handover procedure.

As shown by reference number 510, following handover, the UE 405 may store the previous serving cell identifier (ID) or similar information in a database or other storage location. For example, the UE 405 may record the previous serving cell ID (e.g., the ID of the source network entity 410) in an internal database maintained in memory (e.g., memory 282) of the UE 405. Additionally, and as shown by reference number 515, the UE 405 may start a timer. For example, in some aspects the UE 405 may start a 30 second timer, while, in some other aspects, the UE 405 may start a timer that is longer or shorter than 30 seconds. In some aspects, the timer may be associated with a period of time during which the UE 405 may apply a bias to measurements associated with the previous serving cell (in this example, the source cell) in order to render the previous serving cell harder to trigger for handover purposes, thereby avoiding a ping-pong handover, or the like. That is, in the example in which the timer is 30 seconds in duration, the UE 405 may apply a bias to measurements associated with the previous serving cell for 30 seconds, making it more difficult for the previous serving cell to satisfy handover conditions (e.g., an A3 measurement event) prior to the 30 seconds elapsing.

More particularly, as shown at reference number 520, when performing handover-based measurements, such as RSRP, RSRQ, RSSI, SNR, SINR, or the like, or when otherwise performing handover-related tasks, the UE 405 may determine whether the timer has expired. If the timer has expired, shown as “Yes” at the block indicated by reference number 520, the UE 405 may perform a handover evaluation (e.g., an A3 measurement event evaluation) without applying a bias or penalty to the previous serving cell, as shown by reference number 525. Put another way, once the timer has expired, the UE 405 may perform the A3 measurements in a substantially similar manner as described in connection with FIG. 4. However, if the timer has not expired, shown as “No” at the block indicated by reference number 520, the UE 405 may perform the A3 measurements by applying a bias to a previous serving cell in order to avoid a ping-pong handover, or the like.

More particularly, as shown by reference numbers 530 and 535, the UE 405 may determine two measurement parameters. The first parameter, indicated as P in the block shown by reference number 530, may be associated with a sum of a network configured A3 offset (e.g., the Off or a3-Offset described in connection with FIG. 4) and a network configured hysteresis parameter (e.g., the Hys or hysteresis described in connection with FIG. 4). That is, P may be equal to, or associated with, a3-Offset+hysteresis. The second parameter, indicated as (in the block shown by reference number 535, may be a candidate value (sometimes referred to as a desired value) to replace P in a measurement comparison in order to discourage selection of an associated cell (e.g., the previous serving cell in this example). That is, Q may be a parameter that is associated with a minimum difference between measurements of a neighbor cell and the current serving cell that must be achieved before an A3 measurement event is satisfied and/or before the UE 405 will transmit an A3 measurement report to the current serving cell to trigger a handover procedure.

As shown by the dashed arrow leading from the block indicated by reference number 510 to the block indicated by reference number 535, the (parameter may be based at least in part on whether a cell being measured is a previous serving cell, which, in some aspects, may be determined by the previous serving cell ID stored in the database. For example, a bias may be applied to multiple cells during the time period (e.g., 30 seconds) following handover, but with a larger bias applied to a previous serving cell than applied to other neighboring cells. As shown by reference number 540, in some aspects, the (parameter may additionally, or alternatively, be based at least in part on a measurement associated with the current serving cell. For example, if the measurement exceeds a measurement threshold, indicating a relatively strong current serving cell, a larger Q parameter may be used to discourage additional cell-switching during the time period, and if the measurement does not exceed a measurement threshold, indicating a relatively weak current serving cell, a smaller Q parameter may be used to permit cell-switching more easily.

More particularly, in some aspects, the measurement of the current serving cell may be an RSRP measurement, a measurement threshold may be a threshold RSRP measurement (such as a value expressed in decibel-milliwatts (dBm)), and the candidate (parameter may be associated with a difference between a neighboring cell RSRP measurement and a serving cell RSRP measurement (which may be expressed in decibels (dB)). In such an example, if a previous serving cell is being measured, and if an RSRP measurement associated with the current serving cell is less than a threshold (e.g., less than-105 dBm), then the Q parameter associated with the previous serving cell may be a first value (e.g., 4 dB). Alternatively, if the RSRP measurement associated with the current serving cell is greater than a threshold (e.g., greater than −105 dBm), then the Q parameter associated with the previous serving cell may be a second value greater than the first value (e.g., 6 dB). For other neighboring cells (e.g., cells that are not the previous serving cell), similar Q parameters may be used, or else smaller Q parameters may be used. Returning to the above-described example, a Q parameter associated with a neighboring cell that is not a previous serving cell may be smaller than the Q parameter associated with the previous serving cell. For example, a Q parameter associated with a neighboring cell that is not a previous serving cell may be 2 dB while the Q parameter associated with the previous serving cell is one of 4 dB or 6 dB, as described above.

In some aspects, when making an A3 measurement event evaluation (e.g., when determining whether to send a measurement report, as described in connection with reference number 445), the UE 405 may determine whether the (parameter or the P parameter is larger, and may compare measurements of two cells based at least in part on the larger of the two parameters. More particularly, as shown by reference number 545, the UE 405 may determine whether the configured parameter (e.g., the P parameter) is smaller than the desired value (e.g., the (parameter). If the P parameter is not smaller than the Q parameter for a given cell (shown as “No” at the block indicated by reference number 545), the UE 405 may perform the A3 measurement event evaluation using the configured P parameter (e.g., may perform the A3 measurement event evaluation without applying any bias to the cell being evaluated, as shown at reference number 525). However, if the P parameter is smaller than the Q parameter for a given cell (shown as “Yes” at the block indicated by reference number 545), the UE 405 may perform the A3 measurement event evaluation using the Q parameter (e.g., may perform the A3 measurement event evaluation by applying a bias to the cell being evaluated, as shown at reference number 550). In such instances, a value of the bias applied may be considered to be Q−P.

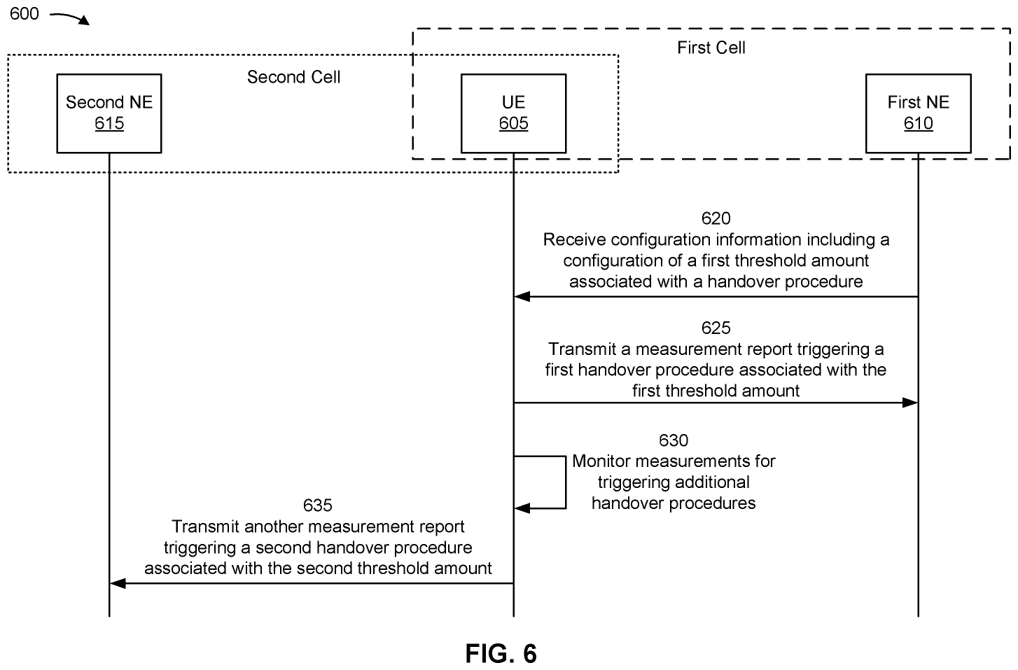

In that regard, the greater of the P parameter (which may be associated with a sum of an A3 offset plus a hysteresis parameter) or the Q parameter may be used when evaluating a handover based on the A3 condition described above in connection with FIG. 4. For example, if the P parameter is larger, the UE 405 may transmit a measurement report triggering a handover procedure if Mn>Mp+P, where P is equal to a sum of a3-offset and hysteresis (ignoring, for ease of discussion, any effect of other configured offsets, if any, such as Ofn, Ocn, Ofp, Ocp, or the like). On the other hand, if the Q parameter is larger, the UE 405 may transmit a measurement report triggering a handover procedure if Mn>Mp+Q (which, in turn, applies a bias to the A3 measurement event evaluation equal to Q−P). Put another way, when Q is larger than P (shown as “Yes” at the block indicated by reference number 545), when performing the A3 measurement event evaluation, a sum of a3-offset and hysteresis may be replaced by Q, thereby making it more difficult to trigger a handover to the associated neighboring cell. Aspects of applying a bias to a neighboring cell are described in more detail in connection with FIG. 6.

As indicated above, FIG. 5 is provided as an example. Other examples may differ from what is described with respect to FIG. 5.

FIG. 6 is a diagram of an example 600 associated with handover measurements associated with multiple threshold amounts, in accordance with the present disclosure. As shown in FIG. 6, a UE 605 (e.g., UE 405) may communicate with a first network entity 610 (e.g., source network entity 410) and a second network entity 615 (e.g., target network entity 415). In some aspects, the UE 605, the first network entity 610, and the second network entity 615 may be part of a wireless network (e.g., wireless network 100). The UE 605 and the first network entity 610 may have established a wireless connection prior to operations shown in FIG. 6. In some aspects, the first network entity 610 may be associated with a first cell, and the second network entity 615 may be associated with a second cell. Moreover, the UE 605 may be within coverage of the first cell and the second cell, as shown, and thus may perform measurements of reference signals or the like received within each cell for purposes of A3 measurement event evaluation or other handover-related determinations, as described in connection with FIGS. 4 and 5.

As shown by reference number 620, the UE 605 may receive, from the first network entity 610, configuration information. In some aspects, the UE 605 may receive the configuration information via one or more of RRC signaling, one or more MAC control elements (MAC-CEs), and/or downlink control information (DCI), among other examples. In some aspects, the configuration information may include an indication of one or more configuration parameters (e.g., already known to the UE 605 and/or previously indicated by the first network entity 610 or other network entity) for selection by the UE 605, and/or explicit configuration information for the UE 605 to use to configure the UE 605, among other examples.

In some aspects, the configuration information may include a configuration of parameters associated with a handover measurement event and/or a handover procedure, such as a first threshold amount associated with a handover measurement event and/or a handover procedure. For example, the configuration information may include a configuration of one or more offsets or related parameters associated with an A3 measurement event. In some aspects, the first threshold amount may be based at least in part on an A3 offset parameter (e.g., Off and/or a3-Offset defined within reportConfigNR) and/or a hysteresis parameter (e.g., Hys and/or hysteresis defined within reportConfigNR). For example, in some aspects, the first threshold amount may be associated with a sum of an offset parameter and a hysteresis parameter. The configuration information may include additional offsets or similar parameters, such as measurement object specific offsets (e.g., offsetMO) defined within measObjectNR corresponding to the first cell and/or the frequency of the second cell), cell specific offsets (cellIndividualOffset defined within measObjectNR corresponding to the first cell and/or the frequency of the second cell), or similar offsets. The UE 605 may configure itself based at least in part on the configuration information. In some aspects, the UE 605 may be configured to perform one or more operations described herein based at least in part on the configuration information.

As shown by reference number 625, the UE 605 may transmit, to the first network entity 610 associated with the first cell, a measurement report triggering a first handover procedure from the first cell to the second cell. For example, the first threshold amount may be associated with an A3 measurement event (e.g., a target cell becoming offset better than a source cell), and thus the measurement report may be transmitted to the first network entity 610 based at least in part on a second measurement associated with the second cell being greater than a first measurement associated with the first cell by the first threshold amount. More particularly, if P is used to represent the first threshold amount (which, in some aspects, may be equal to a3-Offset+hysteresis, as described), the measurement report may be transmitted to the first network entity 610 based at least in part on the second measurement (e.g., Mn) being greater than the first measurement (e.g., Mp) by the first threshold amount (e.g., Mn Mp+P), as described in connection with FIG. 5. In some aspects, at least one of the first measurement or the second measurement is associated with one of an RSRP measurement, an RSRQ measurement, an RSSI measurement, an SNR measurement, or an SINR measurement.

As shown by reference number 630, the UE 605 may monitor measurements (e.g., RSRP, RSRQ, RSSI, SNR, SINR, or a similar measurement) for triggering additional handover procedures, such as from the second cell back to the first cell and/or from the second cell to another neighboring cell (e.g., a third cell). For example, the UE 605 may monitor the first measurement and the second measurement for triggering a second handover procedure from the second cell to the first cell. In some aspects, during at least a time period following the first handover procedure, a second measurement report is transmitted (e.g., from the UE 605 to the second network entity 615), triggering the second handover procedure if the first measurement is greater than the second measurement by a second threshold amount that is greater than the first threshold amount. For example, the second threshold amount may correspond to a biased threshold amount, such as the Q parameter described in connection with FIG. 5. In that regard, in some aspects, the second threshold amount may be applied during at least the time period following the first handover procedure based at least in part on the first cell being the previous serving cell of the UE 605. More particularly, the second threshold amount may be applied in order to discourage handover back to the previous serving cell during the time period (e.g., 30 seconds), as described. That is, a bias may be applied to the first cell (which may be equal to the second threshold value less the first threshold value, or Q−P, as described) when the first cell is a previous serving cell, as described in connection with FIG. 5. In some aspects, monitoring the first measurement and the second measurement for triggering another handover procedure may include monitoring whether the first measurement is greater than the second measurement by the second threshold amount for the time period, and then, after the time period has elapsed, monitoring whether the first measurement is greater than the second measurement by the first threshold amount.

Additionally, or alternatively, in some aspects, the second threshold amount may be equal to a maximum value of a configured threshold amount (e.g., P) and a biased threshold amount (e.g., Q) as described in connection with the block indicated by reference number 545 in FIG. 5. In aspects in which the second threshold amount is equal to the configured threshold amount (e.g., P), the second threshold amount may be associated with a sum of an offset parameter (e.g., Off and/or a3-Offset) and a hysteresis parameter (e.g., Hys and/or hysteresis), as described. And, in some aspects, the biased threshold amount may be based at least in part on the second measurement. That is, as described in connection with the blocks indicated by reference numbers 535 and 540 in FIG. 5, in some aspects, the biased threshold amount may be greater when a measurement of the current serving cell (e.g., the second measurement) indicates that the current serving cell is a strong cell. Thus, in some aspects, based at least in part on the second measurement being less than a threshold measurement value (e.g., −105 dBm, as described in connection with FIG. 5), the biased threshold amount may be equal to a first biased value (e.g., 4 dB, as described in connection with FIG. 5), while, in some other aspects, based at least in part on the second measurement being greater than the threshold measurement value (e.g., −105 dBm), the biased threshold amount may be equal to a second biased value greater than the first biased value (e.g., 6 dB, as described in connection with FIG. 5).

In some aspects, the UE 605 may monitor measurements associated with neighboring cells in addition to the first cell (e.g., the previous serving cell). For example, in connection with the monitoring step shown by reference number 630, the UE 605 may monitor a third measurement associated with a third cell for triggering a third handover procedure from the second cell to the third cell. The third cell may be a neighboring cell that is not a previous serving cell, and thus may be associated with different offset values and/or thresholds than the first cell, which is a previous serving cell. For example, during the time period, the third handover procedure may be triggered if the third measurement is greater than the second measurement by the first threshold amount (e.g., P), rather than the second threshold amount (e.g., Q).

Alternatively, the third serving cell may be associated with a biased threshold amount, similar to the previous serving cell (e.g., the first cell), but the biased threshold amount may be less than a biased threshold amount applied to the first cell. More particularly, in some aspects, during at least the time period following the first handover procedure, the third handover procedure may be triggered if the third measurement is greater than the second measurement by a third threshold amount, with the third threshold amount being greater than the first threshold amount and less than the second threshold amount. In some aspects, the third threshold amount may be associated with a sum of an offset parameter associated with the third cell (e.g., Off and/or a3-Offset) and a hysteresis parameter associated with the third cell (e.g., Hys and/or hysteresis). Additionally, or alternatively, the third threshold amount may be a maximum value between a configured threshold amount (e.g., P) and a biased threshold amount (e.g., the Q parameter associated with the third cell).

As shown by reference number 635, in some aspects, the UE 605 may transmit a measurement report to the second network entity 615 in order to trigger a handover procedure from the second cell to another cell (e.g., back to the first cell, to the third cell, or to another neighboring cell). For example, the UE 605 may transmit, to the second network entity 615 associated with the second cell, the second measurement report triggering the second handover procedure from the second cell to the first cell based at least in part on the first measurement being greater than the second measurement by the second threshold amount. Put another way, in aspects in which the previous serving cell (in this example, the first cell) becomes offset better than the current serving cell (in this example, the second cell) by a significant margin (e.g., the second threshold amount or biased amount), the UE 605 may transmit an A3 measurement report triggering a handover procedure back to the previous cell. In this regard, the UE 605 will not foreclose measurement reports associated with previous serving cells, but rather may require greater offsets and/or thresholds to be overcome before sending a measurement report associated with a previous serving cell, thus resulting in decreased latency, increased throughput, and more efficient usage of network resources, as described.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 605) performs operations associated with handover measurements associated with multiple threshold amounts.

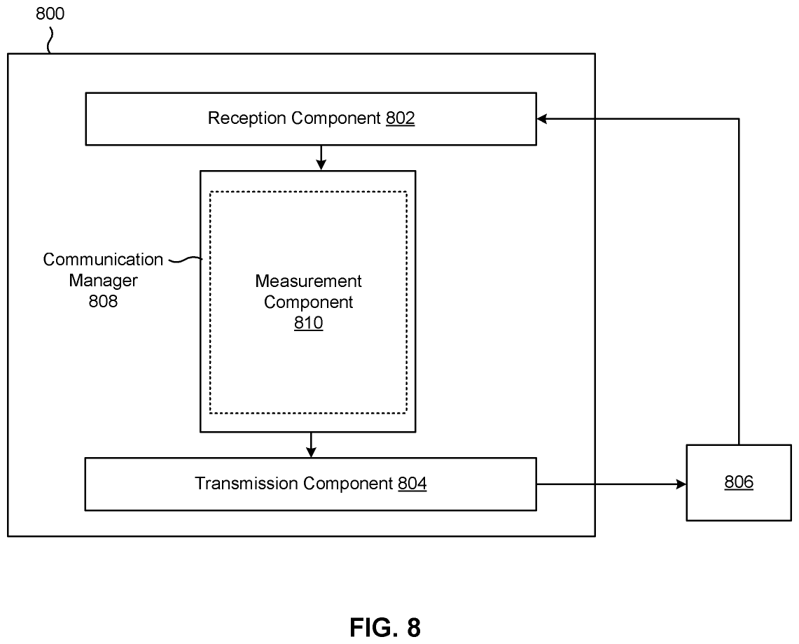

As shown in FIG. 7, in some aspects, process 700 may include transmitting, to a network entity (e.g., first network entity 610) associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount (block 710). For example, the UE (e.g., using communication manager 808 and/or transmission component 804, depicted in FIG. 8) may transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount, as described above.

As further shown in FIG. 7, in some aspects, process 700 may include monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount (block 720). For example, the UE (e.g., using communication manager 808 and/or measurement component 810, depicted in FIG. 8) may monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount, as described above.

Process 700 may include additional aspects, such as any single aspect or any combination of aspects described below and/or in connection with one or more other processes described elsewhere herein.

In a first aspect, the second threshold amount is applied during at least the time period following the first handover procedure based at least in part on the first cell being a previous serving cell of the UE.

In a second aspect, alone or in combination with the first aspect, process 700 includes transmitting, to another network entity associated with the second cell (e.g., the second network entity 615), the second measurement report triggering the second handover procedure from the second cell to the first cell based at least in part on the first measurement being greater than the second measurement by the second threshold amount.

In a third aspect, alone or in combination with one or more of the first and second aspects, the first threshold amount is associated with an A3 measurement event.

In a fourth aspect, alone or in combination with one or more of the first through third aspects, at least one of the first threshold amount or the second threshold amount is associated with a sum of an offset parameter and a hysteresis parameter.

In a fifth aspect, alone or in combination with one or more of the first through fourth aspects, at least one of the first measurement or the second measurement is associated with one of a reference signal received power measurement or a signal to noise ratio measurement.

In a sixth aspect, alone or in combination with one or more of the first through fifth aspects, the second threshold amount is a maximum value between a configured threshold amount and a biased threshold amount.

In a seventh aspect, alone or in combination with one or more of the first through sixth aspects, the biased threshold amount is based at least in part on the second measurement.

In an eighth aspect, alone or in combination with one or more of the first through seventh aspects, based at least in part on the second measurement being less than a threshold measurement value, the biased threshold amount is equal to a first biased value, and, based at least in part on the second measurement being greater than the threshold measurement value, the biased threshold amount is equal to a second biased value greater than the first biased value.

In a ninth aspect, alone or in combination with one or more of the first through eighth aspects, monitoring the first measurement and the second measurement for triggering another handover procedure includes monitoring whether the first measurement is greater than the second measurement by the second threshold amount for the time period, and then, after the time period has elapsed, monitoring whether the first measurement is greater than the second measurement by the first threshold amount.

In a tenth aspect, alone or in combination with one or more of the first through ninth aspects, process 700 includes monitoring a third measurement associated with a third cell for triggering a third handover procedure from the second cell to the third cell.

In an eleventh aspect, alone or in combination with one or more of the first through tenth aspects, the third handover procedure is triggered if the third measurement is greater than the second measurement by the first threshold amount.

In a twelfth aspect, alone or in combination with one or more of the first through eleventh aspects, during at least the time period following the first handover procedure, the third handover procedure is triggered if the third measurement is greater than the second measurement by a third threshold amount, and the third threshold amount is greater than the first threshold amount and less than the second threshold amount.

In a thirteenth aspect, alone or in combination with one or more of the first through twelfth aspects, the third threshold amount is a maximum value between a configured threshold amount and a biased threshold amount.

In a fourteenth aspect, alone or in combination with one or more of the first through thirteenth aspects, the third threshold amount is associated with a sum of an offset parameter associated with the third cell and a hysteresis parameter associated with the third cell.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE (e.g., UE 605), or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a network entity, or another wireless communication device) using the reception component 802 and the transmission component 804. As further shown, the apparatus 800 may include the communication manager 808 (e.g., communication manager 140). The communication manager 808 may include a measurement component 810, among other examples.

In some aspects, the apparatus 800 may be configured to perform one or more operations described herein in connection with FIGS. 5-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE 120 described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE 120 described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE 120 described in connection with FIG. 2. In some aspects, the transmission component 804 may be co-located with the reception component 802 in a transceiver.

The transmission component 804 and/or the measurement component 810 may transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount. The measurement component 810 may monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

The transmission component 804 and/or the measurement component 810 may transmit, to another network entity associated with the second cell, the second measurement report triggering the second handover procedure from the second cell to the first cell based at least in part on the first measurement being greater than the second measurement by the second threshold amount.

The measurement component 810 may monitor a third measurement associated with a third cell for triggering a third handover procedure from the second cell to the third cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: transmitting, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount; and monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.
Aspect 2: The method of Aspect 1, wherein the second threshold amount is applied during at least the time period following the first handover procedure based at least in part on the first cell being a previous serving cell of the UE.
Aspect 3: The method of any of Aspects 1-2, further comprising transmitting, to another network entity associated with the second cell, the second measurement report triggering the second handover procedure from the second cell to the first cell based at least in part on the first measurement being greater than the second measurement by the second threshold amount.
Aspect 4: The method of any of Aspects 1-3, wherein the first threshold amount is associated with an A3 measurement event.
Aspect 5: The method of any of Aspects 1-4, wherein at least one of the first threshold amount or the second threshold amount is associated with a sum of an offset parameter and a hysteresis parameter.
Aspect 6: The method of any of Aspects 1-5, wherein at least one of the first measurement or the second measurement is associated with one of a reference signal received power measurement or a signal to noise ratio measurement.
Aspect 7: The method of any of Aspects 1-6, wherein the second threshold amount is a maximum value between a configured threshold amount and a biased threshold amount.
Aspect 8: The method of Aspect 7, wherein the biased threshold amount is based at least in part on the second measurement.
Aspect 9: The method of Aspect 8, wherein, based at least in part on the second measurement being less than a threshold measurement value, the biased threshold amount is equal to a first biased value, and wherein, based at least in part on the second measurement being greater than the threshold measurement value, the biased threshold amount is equal to a second biased value greater than the first biased value.
Aspect 10: The method of any of Aspects 1-9, wherein monitoring the first measurement and the second measurement for triggering another handover procedure includes monitoring whether the first measurement is greater than the second measurement by the second threshold amount for the time period, and then, after the time period has elapsed, monitoring whether the first measurement is greater than the second measurement by the first threshold amount.
Aspect 11: The method of any of Aspects 1-10, further comprising monitoring a third measurement associated with a third cell for triggering a third handover procedure from the second cell to the third cell.
Aspect 12: The method of Aspect 11, wherein the third handover procedure is triggered if the third measurement is greater than the second measurement by the first threshold amount.
Aspect 13: The method of any of Aspects 11-12, wherein, during at least the time period following the first handover procedure, the third handover procedure is triggered if the third measurement is greater than the second measurement by a third threshold amount, wherein the third threshold amount is greater than the first threshold amount and less than the second threshold amount.
Aspect 14: The method of Aspect 13, wherein the third threshold amount is a maximum value between a configured threshold amount and a biased threshold amount.
Aspect 15: The method of any of Aspects 13-14, wherein the third threshold amount is associated with a sum of an offset parameter associated with the third cell and a hysteresis parameter associated with the third cell.
Aspect 16: An apparatus for wireless communication at a device, comprising a processor; memory coupled with the processor; and instructions stored in the memory and executable by the processor to cause the apparatus to perform the method of one or more of Aspects 1-15.
Aspect 17: A device for wireless communication, comprising a memory and one or more processors coupled to the memory, the one or more processors configured to perform the method of one or more of Aspects 1-15.
Aspect 18: An apparatus for wireless communication, comprising at least one means for performing the method of one or more of Aspects 1-15.
Aspect 19: A non-transitory computer-readable medium storing code for wireless communication, the code comprising instructions executable by a processor to perform the method of one or more of Aspects 1-15.
Aspect 20: A non-transitory computer-readable medium storing a set of instructions for wireless communication, the set of instructions comprising one or more instructions that, when executed by one or more processors of a device, cause the device to perform the method of one or more of Aspects 1-15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount; and
monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

2. The apparatus of claim 1, wherein the second threshold amount is applied during at least the time period following the first handover procedure based at least in part on the first cell being a previous serving cell of the UE.

3. The apparatus of claim 1, wherein the one or more processors are further configured to transmit, to another network entity associated with the second cell, the second measurement report triggering the second handover procedure from the second cell to the first cell based at least in part on the first measurement being greater than the second measurement by the second threshold amount.

4. The apparatus of claim 1, wherein the first threshold amount is associated with an A3 measurement event.

5. The apparatus of claim 1, wherein at least one of the first threshold amount or the second threshold amount is associated with a sum of an offset parameter and a hysteresis parameter.

6. The apparatus of claim 1, wherein at least one of the first measurement or the second measurement is associated with one of a reference signal received power measurement or a signal to noise ratio measurement.

7. The apparatus of claim 1, wherein the second threshold amount is a maximum value between a configured threshold amount and a biased threshold amount.

8. The apparatus of claim 7, wherein the biased threshold amount is based at least in part on the second measurement.

9. The apparatus of claim 8, wherein, based at least in part on the second measurement being less than a threshold measurement value, the biased threshold amount is equal to a first biased value, and wherein, based at least in part on the second measurement being greater than the threshold measurement value, the biased threshold amount is equal to a second biased value greater than the first biased value.

10. The apparatus of claim 1, wherein the one or more processors, to monitor the first measurement and the second measurement for triggering another handover procedure, are configured to monitor whether the first measurement is greater than the second measurement by the second threshold amount for the time period, and then, after the time period has elapsed, monitoring whether the first measurement is greater than the second measurement by the first threshold amount.

11. The apparatus of claim 1, wherein the one or more processors are further configured to monitor a third measurement associated with a third cell for triggering a third handover procedure from the second cell to the third cell.

12. The apparatus of claim 11, wherein the third handover procedure is triggered if the third measurement is greater than the second measurement by the first threshold amount.

13. The apparatus of claim 11, wherein, during at least the time period following the first handover procedure, the third handover procedure is triggered if the third measurement is greater than the second measurement by a third threshold amount, wherein the third threshold amount is greater than the first threshold amount and less than the second threshold amount.

14. The apparatus of claim 13, wherein the third threshold amount is a maximum value between a configured threshold amount and a biased threshold amount.

15. The apparatus of claim 13, wherein the third threshold amount is associated with a sum of an offset parameter associated with the third cell and a hysteresis parameter associated with the third cell.

16. A method of wireless communication performed by a user equipment (UE), comprising:
transmitting, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount; and
monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

17. The method of claim 16, wherein the second threshold amount is applied during at least the time period following the first handover procedure based at least in part on the first cell being a previous serving cell of the UE.

18. The method of claim 16, further comprising transmitting, to another network entity associated with the second cell, the second measurement report triggering the second handover procedure from the second cell to the first cell based at least in part on the first measurement being greater than the second measurement by the second threshold amount.

19. The method of claim 16, wherein the second threshold amount is a maximum value between a configured threshold amount and a biased threshold amount.

20. The method of claim 19, wherein the biased threshold amount is based at least in part on the second measurement.

21. The method of claim 16, wherein monitoring the first measurement and the second measurement for triggering another handover procedure includes monitoring whether the first measurement is greater than the second measurement by the second threshold amount for the time period, and then, after the time period has elapsed, monitoring whether the first measurement is greater than the second measurement by the first threshold amount.

22. The method of claim 16, further comprising monitoring a third measurement associated with a third cell for triggering a third handover procedure from the second cell to the third cell.

23. The method of claim 22, wherein the third handover procedure is triggered if the third measurement is greater than the second measurement by the first threshold amount.

24. The method of claim 22, wherein, during at least the time period following the first handover procedure, the third handover procedure is triggered if the third measurement is greater than the second measurement by a third threshold amount, wherein the third threshold amount is greater than the first threshold amount and less than the second threshold amount.

25. The method of claim 24, wherein the third threshold amount is a maximum value between a configured threshold amount and a biased threshold amount.

26. A non-transitory computer-readable medium storing a set of instructions for wireless communication, the set of instructions comprising:
one or more instructions that, when executed by one or more processors of a user equipment (UE), cause the UE to:
transmit, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount; and
monitor the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

27. The non-transitory computer-readable medium of claim 26, wherein the second threshold amount is applied during at least the time period following the first handover procedure based at least in part on the first cell being a previous serving cell of the UE.

28. The non-transitory computer-readable medium of claim 26, wherein the one or more instructions further cause the UE to transmit, to another network entity associated with the second cell, the second measurement report triggering the second handover procedure from the second cell to the first cell based at least in part on the first measurement being greater than the second measurement by the second threshold amount.

29. An apparatus for wireless communication, comprising:
means for transmitting, to a network entity associated with a first cell, a measurement report triggering a first handover procedure from the first cell to a second cell, wherein the measurement report is transmitted to the network entity based at least in part on a second measurement associated with the second cell being greater than a first measurement associated with the first cell by a first threshold amount; and
means for monitoring the first measurement and the second measurement for triggering a second handover procedure from the second cell to the first cell, wherein, during at least a time period following the first handover procedure, a second measurement report is transmitted triggering the second handover procedure if the first measurement is greater than the second measurement by a second threshold amount that is greater than the first threshold amount.

30. The apparatus of claim 29, wherein the second threshold amount is applied during at least the time period following the first handover procedure based at least in part on the first cell being a previous serving cell of the apparatus.
